(19) United States
(12) Patent Application Publication
(10) Pub. No.: US 2007/0116225 A1
(43) Pub. Date: May 24, 2007

(54) Systems and methods for efficient hybrid conferencing

(76) Inventors: Wei Zhao, Alpharetta, GA (US); Xiaofeng Gao, Alpharetta, GA (US)

Correspondence Address: WALTERS & ZIMMERMAN, PLLC, PO BOX 3822, CARY, NC, 27519, US

(21) Appl. No.: 11/260,299

(22) Filed: Oct. 27, 2005

(51) Int. Cl. H04M 3/42

(52) U.S. Cl. 379/202.01

(57) ABSTRACT

A hybrid conferencing module leverages reservation-based conferencing features, on-demand (ad-hoc) conferencing features, and dynamic conferencing features to access, allocate, and/or otherwise manage ports of one or more allocated conference bridges, one or more bridge gateways, and/or a conferencing gateway. According to some of the exemplary embodiments, the conference gateway communicates with a plurality of conference bridges to identify one or to the available ports needed for an excess participant (e.g., a participant that cannot connect to a conference via the ports of the allocated conference bridge) and then routes the excess participant to the available “shared” port, configures the available “shared” port to access the host participant's conference bridge, and connects the excess participant to the conference call.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

The exemplary embodiments relate to conferencing over telecommunications and/or data networks and, more particularly, to efficient management of distributed conference ports.

Bandwidth is a problem when conferencing. Video and/or desktop conferencing, such as conference sessions, training sessions, and distributed presentations, require available conferencing ports with bandwidth to support communications among the participants and may also include bandwidth to support streaming of any presentation materials. If the participants are few in number, and/or if the file size of the presentation materials is manageable, then current conferencing technology may provide adequate communications and adequate quality of the presentation materials. If, however, there are a large number of host participants, a large number of participants, and/or if the file size of the materials is quite large, then communications and data streaming pose problems. As the number of participants (including host participants) increases and/or as the file size of the presentation materials increases, the required bandwidth also increases. Fifty (50) participants, for example, require fifty (50) conference ports, and, if there are presentation materials, then also require fifty data streams fanning out from a host computer. As the number of participants increases, the host communications system (e.g., communications device, computer, conferencing system, etc.) is also taxed to manage communications with all the participants. All the participants to the conference, then, may eventually suffer from unavailability, from network congestion, and/or from degradation in processor performance of the communications system. Consequently, availability and/or the quality of the conference may be reduced, and the participants to the conference may have a less-than-desirable experience.

Conventional conferencing systems include reservation-based conferencing and on-demand conferencing. Reservation based conferencing provides a guaranteed number of reserved ports and allocates these guaranteed ports regardless if all of the ports are needed. On-demand conferencing provides a conferencing bridge and attempts to allocate ports as participants call in; however, on-demand conferencing does not guarantee any available ports such that all participants may not be able to connect to a conference bridge and participate in the conference.

There is, accordingly, a need in the art for methods, systems, and products for improved conferencing among participants. There is also a need for efficient management of bandwidth required when conferencing.

### SUMMARY

According to exemplary embodiments, the needs described above and other needs are met by methods, systems, computer programs, and computer program products that improve conferencing among participants including the host participant and other conference participants. According to some of the embodiments, conference communications assets are dynamically allocated and managed to add in one or more new participants in real-time using a hybrid conferencing system. The hybrid conferencing system leverages both reservation-based conferencing features and on-demand (ad-hoc) conferencing features as well as dynamic conferencing features to access, allocate, and/or otherwise manage ports of one or more conference bridges interfacing with a conference gateway. Still further exemplary embodiments include one or more bridge gateways that communicate with the one or more bridges and with the conferencing gateway. The conference bridge(s), bridge gateway(s), and the conferencing gateway are managed and controlled by a Hybrid Conferencing Module implemented as computer product code (e.g., software) that may reside on a conferencing server, a host participant's communications device, and/or another processing system.

According to exemplary embodiments, the hybrid conferencing system allocates a conferencing bridge (or a shared conferencing bridge resource) to each host user of a communications network. Each host user (or, alternatively a group of host users) is allocated a telephone number and an authentication code to connect to the conference bridge that has a default maximum number of conferencing ports that are “always” available—that is, scheduling and/or operator interaction is not required to set up the conference call. The host user may participate in a conference call as a host participant by dialing a conference telephone number and entering the authentication code to access his/her conference bridge. Other participants connect to the conference bridge by dialing the conference telephone number and entering a conference code (e.g., a PIN). Alternatively, the other participants may connect to the conference bridge by dialing the host participant's phone number, enter the conference code, and automatically be routed to the conference bridge (since the host participant's phone number is associated with the conference bridge). The conference code may be selected by the host participant, or alternatively, the conference code may be selected by the Hybrid Conferencing Module and distributed to the host participant. When the number of conferencing ports for the participants exceeds the default maximum number of conferencing ports allocated to the host participant, the Hybrid Conferencing Module routes each of the excess participants to the conference gateway.

According to some of the exemplary embodiments, the conference gateway communicates with a plurality of conference bridges to identify one or more available ports needed for the excess participants and then automatically assigns each of the excess participants to an available port, configures the available port to access the host participant's conference bridge, and connects the participant to the conference call. The hybrid conferencing system may automatically access available port(s) assigned to another host user (e.g., another host user that is not using his/her conference bridge) and/or another host participant (e.g., another host participant that is not using all of his/her ports allocated to his/her bridge), or, alternatively, the hybrid conferencing system may include a plurality of unassigned ports that are available for configuration and allocation to any of the bridges in the hybrid conferencing system. According to other exemplary embodiments, the Hybrid Conferencing Module may identify an available port(s) allocated to another host user and/or another host participant and then prompt the host user and/or host participant to “share” one or more of his/her available ports. The host user and/or host participant having the available port may agree to “share” and then the Hybrid Conferencing Module will automatically access, configure, and connect the excess participant to the conference call via the “shared” port. Alternatively, the other host user and/or the other host participant may respond to the prompt by requesting additional information (e.g., approximately how long will the conference call last, will the “borrowing” host participant pay a fee and/or provide another incentive to share, and other information) before agreeing to “share” his/her port(s). Still, another alternate exemplary embodiment enables the “borrowing” host user or host participant to specifically select another host participant (e.g., by selecting a name, a phone number, a geographic area, a business group, a host user (or host participant) that identifies available ports to “share” (e.g., a host user that is on vacation and not using his/her bridge), and other identifying information for selecting another host participant). The “borrowing” host user may request the “shared” port(s) prior to the conference call, and the Hybrid Conferencing Module will access, configure, and allocate the “shared” port(s) to the conference call. Similarly, the “borrowing” host participant may request the “shared” port(s) during the conference call, and the Hybrid Conferencing Module will access, configure, and connect the excess participant to the conference call.

Other exemplary embodiments may include features for analyzing communications connections of conference participants and of excess participants to determine optimal assignment of the allocated ports and the “shared” ports. Still other exemplary embodiments may include conference management features including a user interface for the host participant to manage conference resources (including administrative features, a profile of the host participant, a participant profile, “sharing features” such as a request to “borrow” an available port, an offer to “share” an available port, an incentive to “share” an available port, a request for an unassigned port, features to control connections with his/her ports including “shared” ports, and other management features) and to communicate and distribute conference materials. For example, the host participant can execute commands and/or instructions that delay presentment of the conference and/or presentment of conference materials until all participants (including excess participants) are connected with the conference call, modify one or more communications connection with and/or among participants, and/or other features. The communications connection may utilize a variety of communications networks, such as, for example, a telecommunications network (e.g., Public Switched Telephone Network (PSTN)), a data communications network (e.g., an Internet Protocol (IP) communications network), and/or a satellite network. Further exemplary embodiments provide a variety of host participant interfaces for the Hybrid Conferencing Module that include, for example, dual tone multi frequency (DTMF) signals, web-based interfaces (e.g., Internet), e-mail interfaces, interactive voice response interfaces, and others. Accordingly, the hybrid conferencing system leverages conferencing assets to provide an “always” available hybrid conferencing system for the host participant, participants, and/or excess participants.

Other exemplary embodiments describe a computer program product. A computer-readable medium stores a Hybrid Conferencing Module. According to some of the embodiments, the Hybrid Conferencing Module may be stored in a memory device of a host participant's communications device and/or a conference server in communication with a conferencing gateway and one or more communications networks.

Other systems, methods, and/or computer program products according to these and other embodiments will be or become apparent to one with skill in the art upon review of the following drawings and detailed description. It is intended that all such additional systems, methods, and/or computer program products be included within and protected by this description and be within the scope of this invention.

### DESCRIPTION OF THE DRAWINGS

The above and other embodiments, objects, uses, advantages, and novel features are more clearly understood by reference to the following description taken in connection with the accompanying figures, wherein:

FIG. 1 illustrates a block diagram of an operating system according to some of the exemplary embodiments;

FIG. 2 is a schematic illustrating a hybrid conferencing communications system with default allocations of conferencing resources according to some of the exemplary embodiments;

FIG. 3 is a schematic illustrating another hybrid conferencing communications system with default allocations of conferencing resources according to some of the exemplary embodiments;

FIG. 4 is a schematic illustrating a hybrid conferencing communications system with dynamic allocation of available conferencing resources according to some of the exemplary embodiments;

FIG. 5 is a schematic illustrating another hybrid conferencing communications system with allocations of conferencing resources to one of a plurality of communications devices that may be used by the host participant according to some of the exemplary embodiments;

FIG. 6 is a schematic illustrating a hybrid conferencing system with default allocations of conferencing resources according to some of the exemplary embodiments;

FIG. 7 is a schematic illustrating another hybrid conferencing system with default allocations of conferencing resources according to some of the exemplary embodiments;

FIG. 8 is a schematic illustrating still another hybrid conferencing communications system with dynamic allocation of available conferencing resources according to some of the exemplary embodiments; and

FIG. 9 is a schematic illustrating yet another hybrid conferencing communications system with dynamic allocation of available conferencing resources to a plurality of communications devices that may be used by the participants according to some of the exemplary embodiments.

### DESCRIPTION

The exemplary embodiments now will be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, flowcharts, illustrations, and the like represent conceptual views or processes illustrating systems, methods and computer program products embodying this invention. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

The exemplary embodiments include methods, systems, computer programs, and/or computer program products for providing flexible conference resource allocation tools for allocating, accessing, updating, refreshing, sharing, borrowing, and otherwise managing conference resources for hybrid conferencing system. According to some of the embodiments, conference communications assets are dynamically allocated and managed to add in one or more new participants in real-time using a hybrid conferencing system. The hybrid conferencing system leverages both reservation-based conferencing features and on-demand (ad-hoc) conferencing features as well as dynamic conference management features to access, allocate, and/or otherwise manage ports of one or more conference bridges interfacing with a conference gateway. Still further exemplary embodiments include one or more bridge gateways that communicate with the one or more bridges and with the conferencing gateway. The conference bridge(s), bridge gateway(s), and the conferencing gateway are managed and controlled by a Hybrid Conferencing Module implemented as computer product code (e.g., software) that may reside on a conferencing server, a host participant's communications device, and/or another processing system. This improves conferencing among host users, host participants, participants, and/or excess participants. As used herein, the term “host user” is user or a subscriber to the hybrid conferencing system that is allocated a conferencing bridge (or a shared conferencing bridge resource) having a default maximum number of conferencing ports (e.g., 6 ports) that are “always” available—that is, scheduling and/or operator interaction is not required to set up the conference call. As used herein, the term “host participant” is a user or subscriber who participates in a conference by accessing his/her conference bridge (e.g., by dialing a telephone number and entering the authentication code to access his/her conference bridge). As used herein, the term “participant” may include a non-user or non-subscriber as well as another host user that connects to the host participant's conference bridge via an allocated port. As used herein, the term “excess participant” may include a non-user or non-subscriber as well as another host user that connects to the host participant's conference bridge via a “shared” port.

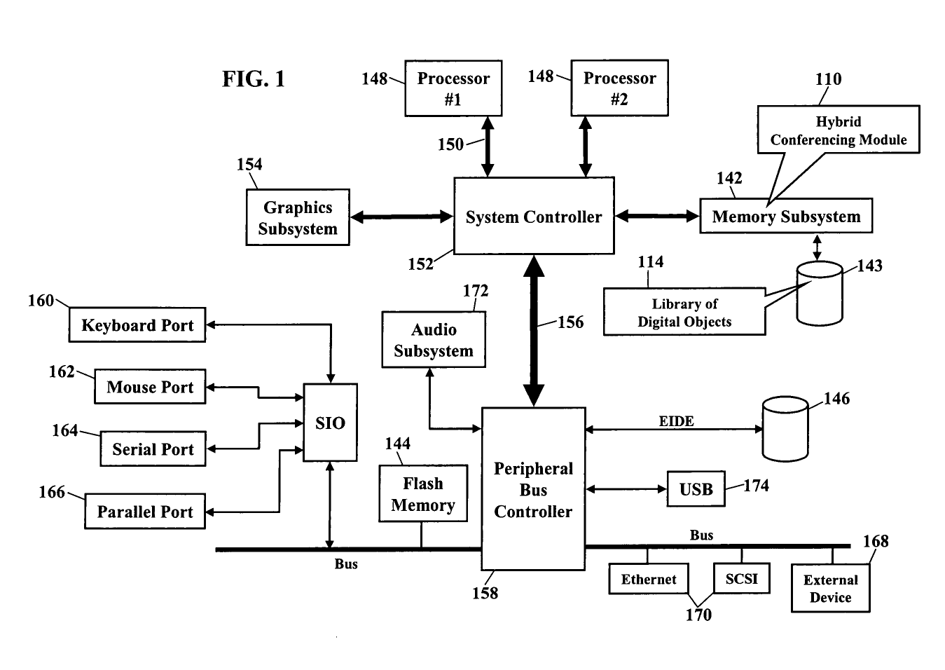

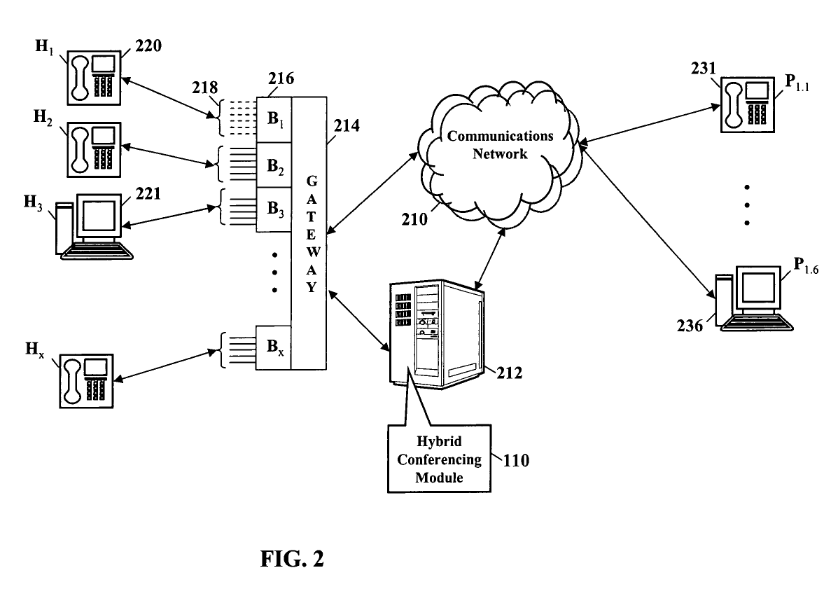

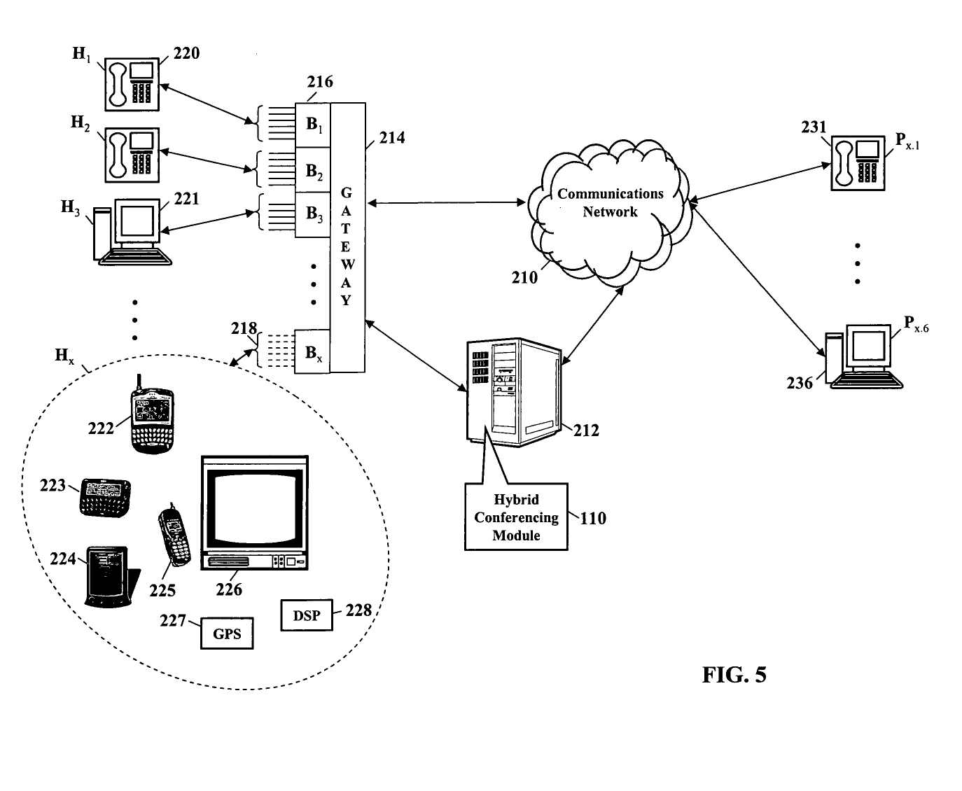

Referring now to the figures, FIG. 1 illustrates a block diagram showing a Hybrid Conferencing Module 110 residing in a communications system 100. The communications system 100 may be a computing system, such as a conference server (shown as reference numeral 212 in FIGS. 2-7), a laptop/desktop computer (shown as reference numeral 221 in FIGS. 2-5), a telecommunications system (shown as reference numeral 220 of FIGS. 2-5), a tablet computer, and/or other computer systems including wired and wireless communications devices (e.g., communications devices 222-228 of FIG. 5). In the embodiments of FIG. 1, the Hybrid Conferencing Module 110 operates within a system memory device. The Hybrid Conferencing Module 110, for example, is shown residing in a memory subsystem 142. The Hybrid Conferencing Module 110, however, could also reside in flash memory 144 or a peripheral storage device 146. The communications system 100 also has one or more central processors 148 executing an operating system. The operating system, as is well known, has a set of instructions that control the internal functions of the communications system 100. A system bus 150 communicates signals, such as data signals, control signals, and address signals, between the central processor 148 and a system controller 152 (typically called a “Northbridge”). According to some embodiments, these signals include conference resource allocation commands and conference management commands described further herein. The system controller 152 provides a bridging function between the one or more central processors 148, a graphics subsystem 154, the memory subsystem 142, and a PCI (Peripheral Controller Interface) bus 156. The PCI bus 156 is controlled by a Peripheral Bus Controller 158. The Peripheral Bus Controller 158 (typically called a “Southbridge”) is an integrated circuit that serves as an input/output hub for various peripheral ports (referred to in FIG. 1 as “SIO” (system input/output)). These peripheral ports are shown including a keyboard port 160, a mouse port 162, a serial port 164 and/or a parallel port 166 for a video display unit, one or more external device ports 168, and networking ports 170 (such as SCSI or Ethernet). The Peripheral Bus Controller 158 also includes an audio subsystem 172. Those of ordinary skill in the art understand that the program, processes, methods, and systems described herein are not limited to any particular communications system or communications hardware. Other architectures are possible, and the Hybrid Conferencing Module 110 can operate in any architecture.

Those of ordinary skill in the art also understand the central processor 148 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), Sun Microsystems, Inc. (4150 Network Circle, Santa Clara Calif. 95054, www.sun.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

According to an exemplary embodiment, UNIX® is the operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Other operating systems, however, are also suitable. Such other operating systems would include a WINDOWS-based operating system (WINDOWS® is a registered trademark of Microsoft Corporation, One Microsoft Way, Redmond Wash. 98052-6399, 425.882.8080, www.Microsoft.com). and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The system memory device (shown as memory subsystem 142, flash memory 144, or peripheral storage device 146) may also contain an application program. The application program cooperates with the operating system and with a video display unit (via the serial port 164 and/or the parallel port 166) to provide a Graphical User Interface (GUI). The Graphical User Interface typically includes a combination of signals communicated along the keyboard port 160 and the mouse port 162. The Graphical User Interface provides a convenient visual and/or audible interface of the Hybrid Conferencing Module 110 with a user of the communications system 100.

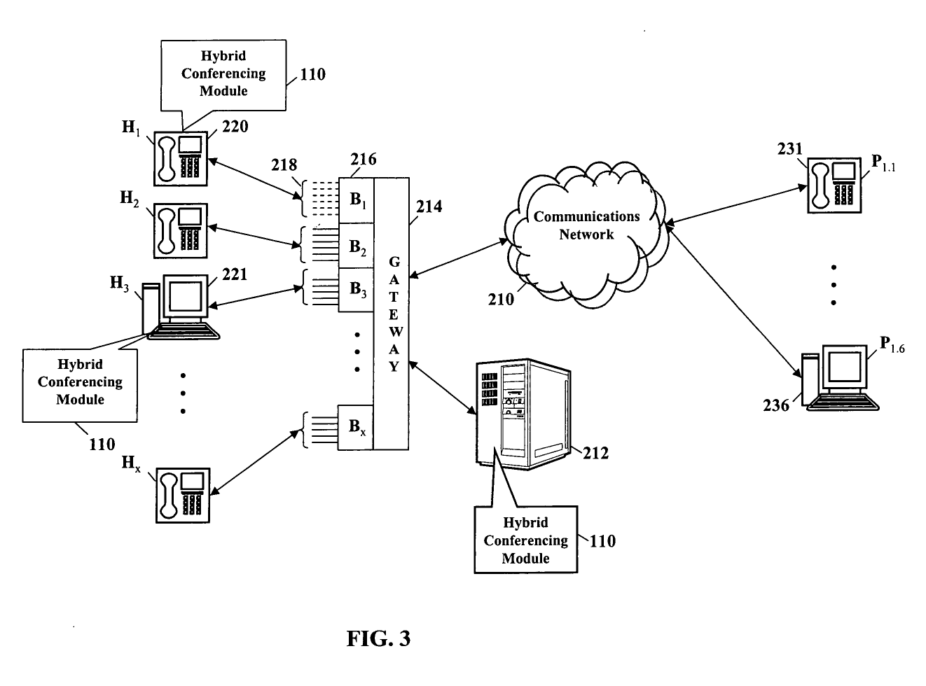

FIGS. 2 and 3 are schematics illustrating exemplary hybrid conferencing communications system. The exemplary embodiment of FIG. 2, illustrates a hybrid conferencing communications system 200 that includes a communications network 210, a conference server 212 having the Hybrid Conferencing Module 110, a conference gateway 214, a plurality of conference bridges 216 (also shown as B₁, B₂, B₃ to Bₓ), a plurality of allocated ports 218 (shown as 6 ports in FIG. 2) for each conference bridge 216, a communications device shown as telephone 220 associated with a host participant H₁, a plurality of other communications devices associated with a plurality of other host users H₂, H₃ to Hₓ, and a plurality of communications devices 231-236 associated with a plurality of participants P₁ thru P₆ engaged in conference call with host participant H₁. The exemplary embodiment of FIG. 3, illustrates a hybrid conferencing communications system 300 similar to the hybrid conferencing communications system 200 of FIG. 2; however, the Hybrid Conferencing Module 110 resides on the telephone 220 associated with the host participant H₁ and a computer 221 associated with host participant Hₓ, instead of (or in addition to) the Hybrid Conferencing Module 110 residing on the conference server 212 such that each host participant H₁, H₃ can use his/her communications device 220, 221 to access, control, and otherwise manage conference communications via the Hybrid Conferencing Module 110.

According to some of the exemplary embodiments, each host user H₁, H₂, H₃ to Hₓ (or, alternatively a group of host users) is allocated a telephone number (or another communications address, such as, for example, a URL of a data communications network) and an authentication code to connect to the conference bridge 216 that has a default maximum number of conferencing ports 218 (e.g., 6 ports as shown in FIG. 2) that are “always” available. Alternatively, the conference bridge 216 may be assigned a maximum bandwidth for each of the ports, or still another alternative is to assign a collective bandwidth to the conference bridge. A host user H₁, H₂, H₃ to Hₓ may participate in a conference call as the host participant H₁ by dialing a telephone number and entering the authentication code to access his/her conference bridge 216. Other participants P₁ thru P₆ connect to the conference bridge 216 by dialing the conference telephone number and entering a conference code (e.g., a PIN, a password, and other verification information to access the conference call). Alternatively, as shown in FIG. 2, the other participants P₁ thru P₆ may connect to the conference bridge 216 by dialing the telephone number of host participant's communications device 220 and entering a conference code. Since the Hybrid Conferencing Module 110 of communications device 220 associates the telephone number of the host participant with a particular conference bridge B₁, the Hybrid Conferencing Module 110 detects and decodes the conferencing code and routes each of the other participants P₁ thru P₆ to the conference bridge 216 for host participant H₁. Further, the Hybrid Conferencing Module 110 residing in the communications device (e.g., computing system 221) of a host user may initially manage communication of the conference session with participants' communications devices (e.g., communications devices 231-236). For example, the communications device may communicate (e.g., via email, instant message, pre-recorded audio message, and other communications over communications network 210) conferencing instructions to the participants' communications devices, such as the conference telephone number, host participant's telephone number, the conference code, the time and day of the conference call, a name of host participant, a name of an invited participant, and other information to identify and set up the conference call. According to exemplary embodiments, the conferencing instructions may be communicated from the telephone 220, the computing system 221, and/or the server 212 to the participants' communications devices via the communications network 210. The communications network 210 may include a telecommunications network (e.g., Public Switched Telephone Network (PSTN), Mobile Switching Telephone Office (MSTO), and others), a data network (e.g., an Internet (sometimes alternatively known as the “World Wide Web”), an intranet, a local-area network (LAN), and/or a wide-area network (WAN)), and/or a satellite network.

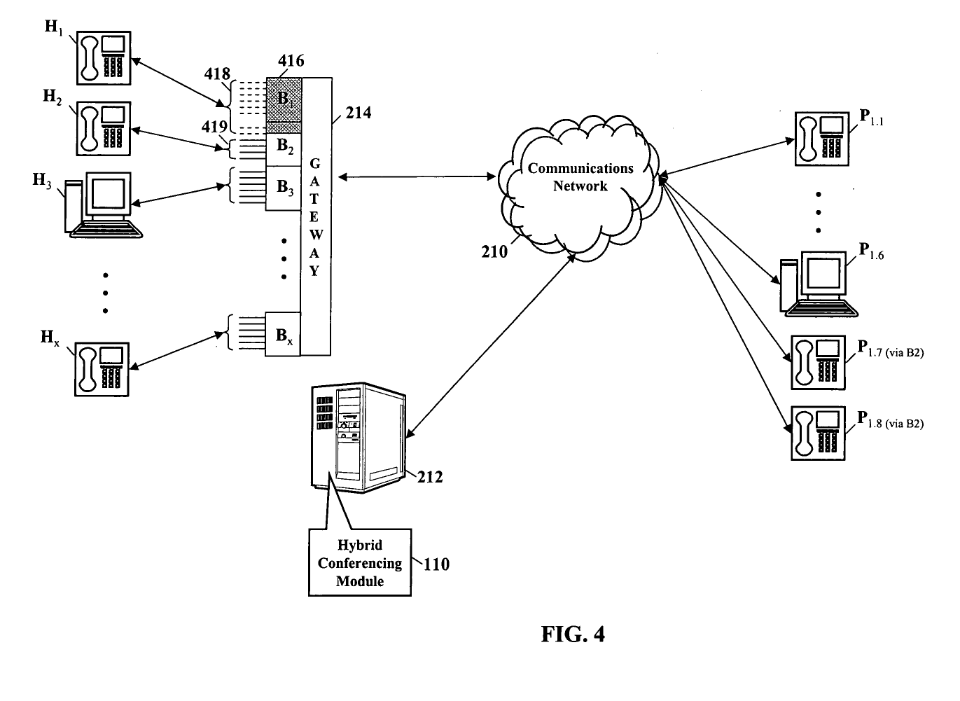

Referring now to an exemplary hybrid conferencing communications system 400 of FIG. 4, when the number of needed conferencing ports for the participants exceeds the default maximum number of conferencing ports (e.g., the 6 ports shown in FIG. 2) allocated to the host participant, the Hybrid Conferencing Module 110 of the conference server 212 routes each excess participant P_{1.7}, P_{1.8} to the conference gateway 214. Thereafter, the conference gateway 214 communicates with the plurality of conference bridges B₁, B₂, B₃ to Bₓ to identify one or more available ports needed for each of the excess participants P_{1.7}, P_{1.8}, selects one or more available ports to “share” for the conference call, routes each of the excess participants P_{1.7}, P_{1.8} to a “shared” port (shown as ports allocated to B₂), configures each of these “shared” ports (shown as ports allocated to B₂) to access the host participant's conference bridge B₁ via gateway 214, and connects each the excess participants P_{1.7}, P_{1.8} to the conference call via the gateway 214. The “shared” ports and the allocated ports 418 are recognized by the gateway 214 as conference resources for an “added-to” conference bridge 416, and the gateway processes conference communications including distribution of conference materials over the “added-to” conference bridge 416.

FIG. 5 illustrates another hybrid conferencing communications system 500 similar to the hybrid conferencing communication system 200 of FIG. 2. However, the hybrid conferencing communications system 500 illustrates alternate host participant communications devices Hₓ that include an Internet Protocol (IP) phone 222, an interactive pager 223, a personal digital assistant (PDA) 224, a cellular/satellite phone 225, an interactive television 226, a Global Positioning System (GPS) device 227, and/or any computer and/or communications device utilizing a digital signal processor (DSP) 228. The alternate host participant communications devices 222-228 communicate with participants P_{x.1}-P_{x.6} on conference bridge Bₓ using allocated ports 218. The alternate host user and/or host participant communications devices 222-228 may also include addressable watches, radios, vehicle electronics, clocks, printers, gateways, and other apparatuses and systems.

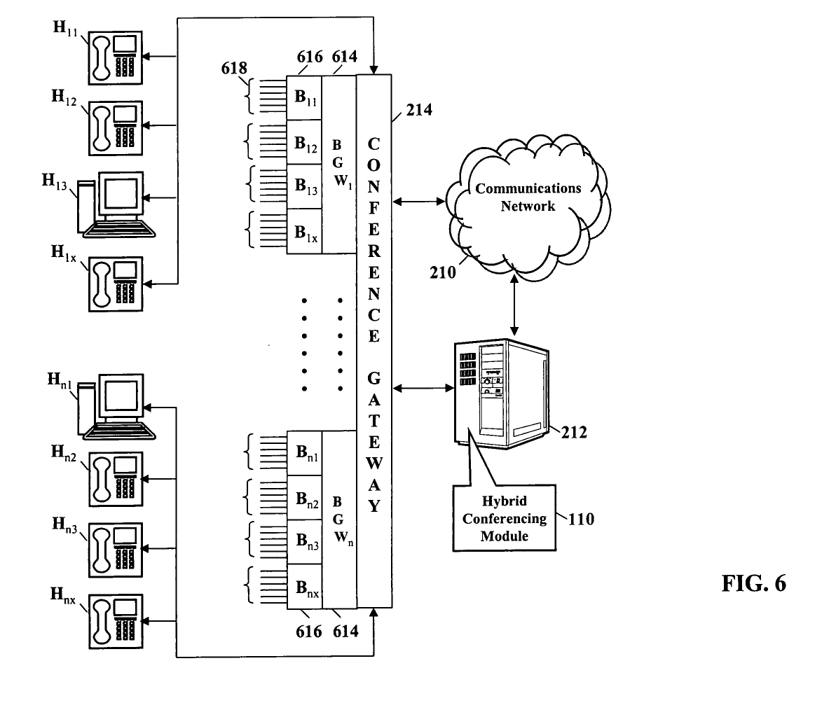

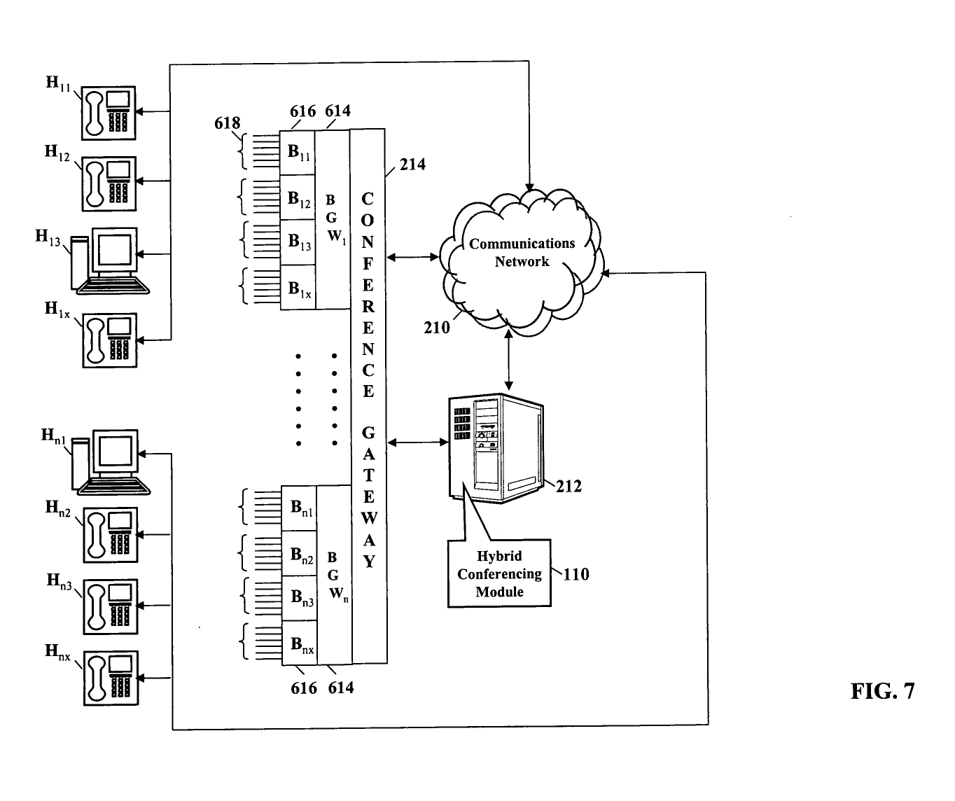

FIG. 6 illustrates an exemplary embodiment of a hybrid conferencing system 600 that includes the communications network 210, the conference server 212 having the Hybrid Conferencing Module 110, the conference gateway 214, a plurality of bridge gateways 614 communicating with one or more selected conference bridges, a plurality of conference bridges 616 (shown as B₁₁-B_{1X} thru Bₙ₁-Bₙₓ) associated with both the host user and the bridge gateway 614, a plurality of allocated ports 618 (shown as 6 ports in FIG. 6) for each conference bridge 616, and a plurality of communications devices, each of the plurality of communications devices associated with one of a plurality of host users H₁₁-H₁ₓ thru Hₙ₁-Hₙₓ. Each of the plurality of communications devices H₁₁-H₁ₓ thru Hₙ₁-Hₙₓ may communicate directly with the conference gateway 214 and/or conference server 216 when the host user dials the conference telephone number and enters his/her authentication code. Alternatively, as shown in an exemplary hybrid conferencing communications system 700 depicted in FIG. 7, each of the plurality of communications devices H₁₁-H₁ₓ thru Hₙ₁-Hₙₓ may communicate via the communications network 210 to access the conference gateway 214 and/or to access the conference server 212 when the host user dials the conference telephone number and enters his/her authentication code. Similar to the above exemplary embodiments, the conference bridge 616 may also be assigned a maximum bandwidth for each of the ports 618, or still another alternative is to assign a collective bandwidth to the conference bridge 616.

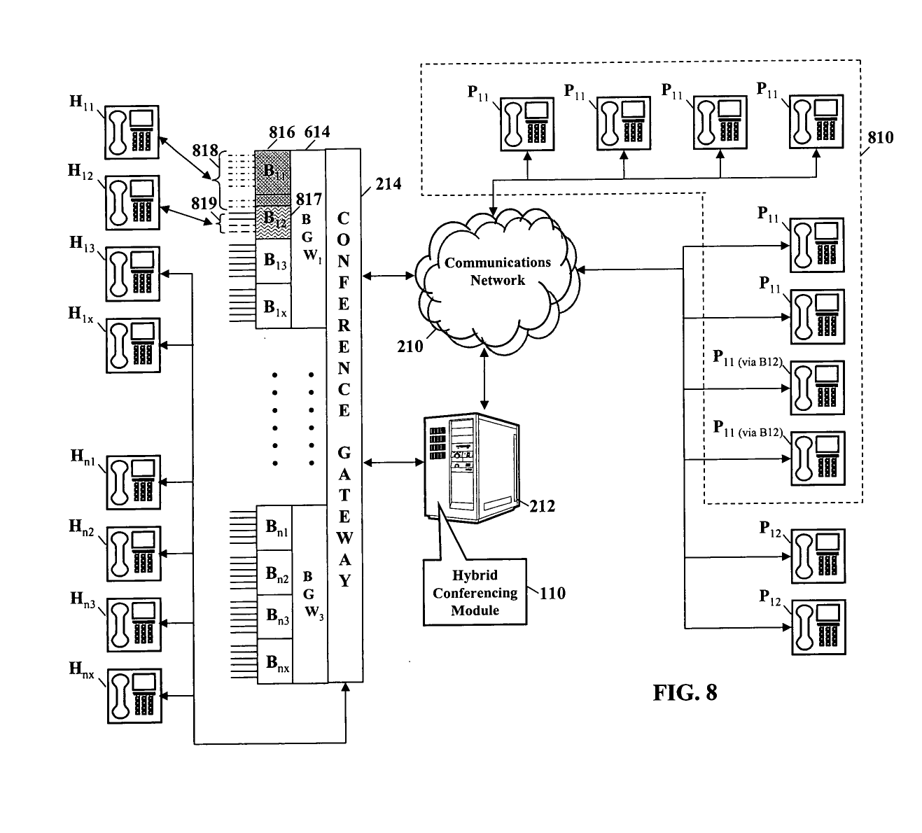

FIG. 8 illustrates an exemplary embodiment of a hybrid conferencing communications system 800 similar to the hybrid conferencing systems 600 and 700 of respective FIGS. 6 and 7. The hybrid conferencing communications system 800 includes the communications network 210, the conference server 212 having the Hybrid Conferencing Module 110, the conference gateway 214, the plurality of bridge gateways 614 associated with selected conference bridges, the plurality of conference bridges (shown as B₁₁-B₁ₓ thru Bₙ₁-Bₙₓ) associated with both the host user (or host participant) and the bridge gateway 614, a plurality of allocated ports 618 for each conference bridge B₁₁-B₁ₓ thru Bₙ₁-Bₙₓ, an “added to” conference bridge 818, a “borrowed from” conference bridge 819, the plurality of host user and/or host participant communications devices, each of the plurality of communications devices associated with one of a plurality of host users or host participants H₁₁-H₁ₓ thru Hₙ₁-Hₙₓ, and a plurality of participant communications devices P₁₁, P₁₂, each of the plurality of participant communications P₁₁, P₁₂ devices associated with one host participant H₁₁, H₁₂. H₁₁ accesses his/her conference bridge B₁₁ when the host user H₁₁ dials the conference telephone number and enters the conference code. The conference bridge(s), bridge gateway(s), and the conferencing gateway are managed and controlled by the Hybrid Conferencing Module 110 implemented as computer product code (e.g., software) that is shown residing on the conferencing server 212. Alternatively, the Hybrid Conferencing Module 110 may reside on the host participant's communications device and/or another processing system.

According to exemplary embodiments, the hybrid conferencing communications system 800 allocates a conferencing bridge B₁₁-B_{1X} thru Bₙ₁-Bₙₓ (or a “shared” conferencing bridge 816) to each host user (or host participant). Each host user (or, alternatively a group of host users and/or host participants) is allocated a telephone number (or other communications access address to his/her conference bridge) and an authentication code to connect to his/her conference bridge that has a default maximum number of conferencing ports that are “always” available. Additionally, the host user may access or may automatically be displayed (or otherwise presented) one or more Graphical User Interfaces (GUIs) of the Hybrid Conferencing Module 110 to manage his/her conference resources. The host user may access or otherwise be presented these GUIs to request additional conference resources for a scheduled time, day, and/or week, request additional allocated ports, offer available, allocated ports (or other conference resources) to share with another host user and/or host participant, confirm a request to “share” his/her allocated ports, manage communications connections of participants and add-in participants to a conference call, manage profile information associated with the host user (e.g., name, billing information, communications preferences, communications addresses such as telephone numbers for work, home, cellular, and a history of conference calls with participant information, date and time of conference call information, and other information). For example, when the number of participants to a conference is greater than the allocated ports, the host user H₁₁ may access (or automatically be presented) a resource management GUI of the Hybrid Conferencing Module 110 to specifically select another host user H₁₂ (e.g., by selecting a name, a phone number, a geographic area, a business group, a host user (or host participant) that identifies available ports to “share” (e.g., a host user that is on vacation and not using his/her bridge), and other identifying information for selecting the other host participant H₁₂) and ask to “borrow” conference resources. The “borrowing” host user H₁₁ may request the “shared” port(s) prior to the conference call, and the Hybrid Conferencing Module 110 accesses, configures, and allocates the “shared” port(s) to the conference call. Similarly, the “borrowing” host participant H₁₁ may request the “shared” port(s) during the conference call, and the Hybrid Conferencing Module 110 then accesses and configures the “shared” port(s) and the hybrid conferencing communications system connects the excess participant to the conference call.

In exemplary embodiments, the host participant H₁₁ dials the conference telephone number and an authentication code to connect to his/her conference bridge. Other participants P₁₁ connect to the conference bridge B₁₁ by dialing the conference telephone number and entering the conference code. Alternatively, the other participants P₁₁ may connect to the conference bridge by dialing the host participant's phone number, enter the conference code, and automatically be routed to the conference bridge B₁₁ (since the host participant's phone number is associated with his/her conference bridge). The conference code may be selected by the host participant H₁₁, or alternatively, the conference code may be selected by the Hybrid Conferencing Module 110 and distributed to the host participant H₁₁ and/or automatically communicated to one or more communications address(es) of other participants P₁₁. When the number of conferencing ports for the participants P₁₁ exceeds the default maximum number of conferencing ports allocated to the host participant H₁₁, the Hybrid Conferencing Module 110 routes each of the excess participants to the conference gateway 214. The conference gateway 214 communicates with the plurality of bridge gateway 614 to identify one or more available ports needed for the excess participants and then automatically assigns each of the excess participants to an available port, configures the available port to access the host participant's conference bridge, and connects the participant to the conference call. Each of the plurality of bridge gateways 614 communicates with one or more selected conference bridges of the plurality of conference bridges B₁₁-B_{1X} thru Bₙ₁-Bₙₓ to manage a grouping of conference bridges For example, BGW₁ manages conference bridges B₁₁-B_{1X} assigned to host users and/or host participants H₁₁-H_{1X}.

The hybrid conferencing communications system 800 may automatically access available port(s) assigned to another host user (e.g., another host user that is not using his/her conference bridge) and/or another host participant (e.g., another host participant that is not using all of his/her ports allocated to his/her bridge), or, alternatively, the hybrid conferencing system 800 may include a plurality of unassigned ports (not shown) that are available for configuration and allocation to any of the conference bridges B₁₁-B_{1X} thru Bₙ₁-Bₙₓ in the hybrid conferencing communications system 800. According to other exemplary embodiments, the Hybrid Conferencing Module 110 may identify an available port(s) allocated to another host user and/or another host participant and then prompt the identified host user and/or host participant to “share” one or more of his/her available ports. The host user and/or host participant having the available port may agree to “share” and then the Hybrid Conferencing Module 110 automatically accesses, configures, and connects the excess participant to the conference call via the “shared” port. Alternatively, the host user and/or the other host participant having available port(s) may respond to the prompt by requesting additional information (e.g., approximately how long will the conference call last, will the “borrowing” host participant pay a fee and/or provide another incentive to share, and other information) before agreeing to “share” his/her port(s). Other exemplary embodiments include features for analyzing communications connections of conference participants and of excess participants to determine optimal assignment of the allocated ports and the “shared” ports.

Regardless of how the “shared” ports are obtained, the hybrid conferencing communications system 800 connects the excess participants with the bridge gateway BGW₁ and the conference bridge of the “borrowing” host participant H₁₁ such that an “added to” conference bridge 816 supports the conference call for all participants (e.g., host participant, participants communicating via allocated ports, and excess participants communicating via “shared” ports). FIG. 8 illustrates the hybrid conferencing system 800 connecting two excess participants P_{11 (via B12)} via two available ports of conference bridge B₁₂ (allocated to sharing host user H₁₂) to the conference call via “added to” conference bridge 816. Still further, the Hybrid Conferencing Module 110 recognizes that sharing host user H₁₂ has use of a remaining number of allocated ports (or, alternatively a remaining bandwidth) shown as 4 remaining ports of conference bridge B₁₂. The Hybrid Conferencing Module 110 recognizes these remaining ports with a temporary “borrowed from” conference bridge 819, and these remaining ports are available for the sharing host participant H₁₂ to use in a conference call with other participants P₁₂.

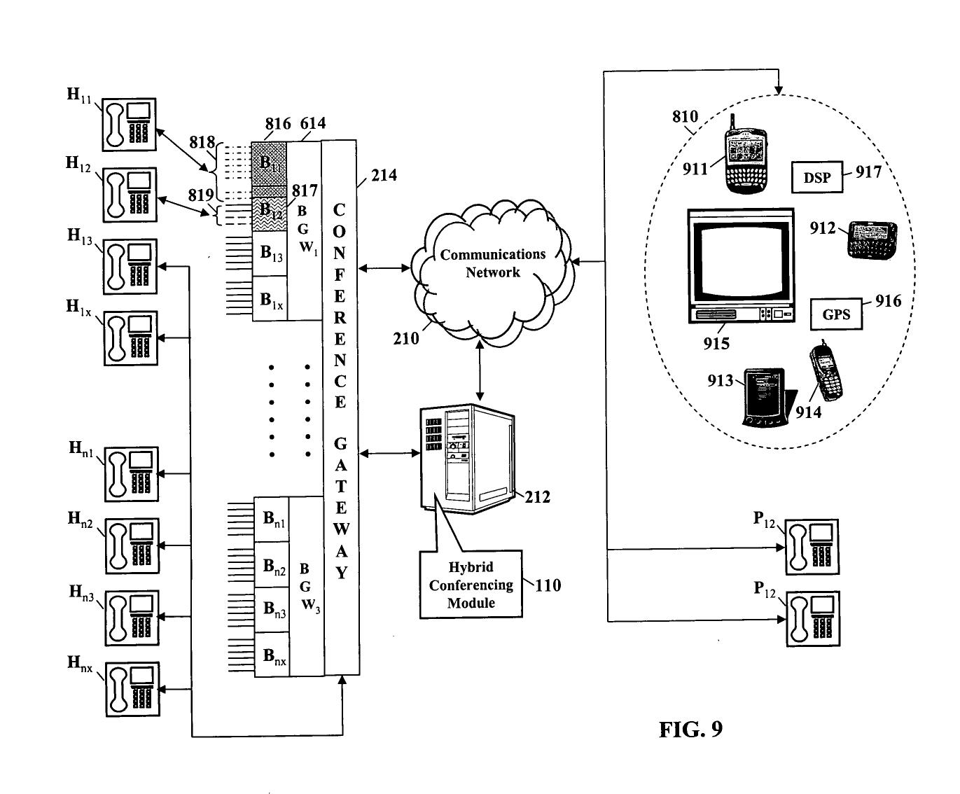

FIG. 9 illustrates another hybrid conferencing communications system 900 similar to the hybrid conferencing communication system 800 of FIG. 8. However, the hybrid conferencing communications system 900 illustrates alternate participant communications devices 810 that include an Internet Protocol (IP) phone 911, an interactive pager 912, a personal digital assistant (PDA) 913, a cellular/satellite phone 914, an interactive television 915, a Global Positioning System (GPS) device 916, and/or any computer and/or communications device utilizing a digital signal processor (DSP) 917. The alternate participant communications devices 810 communicate with host participant H₁₁ via the “added to” conference bridge 816. The alternate participant communications devices 810 may also include addressable watches, radios, vehicle electronics, clocks, printers, gateways, and other apparatuses and systems. These alternate communications device 810 communicate with the conference server 212 (and/or the conference gateway 214 and/or the communications device of the host participant H₁₁) to join the conference call. The Hybrid Conferencing Module 110 analyzes communications factors to determine communications connections for each of the alternate participant communications device 810. For example, the Hybrid Conferencing Module 110 may identify alternate participant communications device 810 as a VoIP phone 911 with signaling via an Internet (or date communications network), a wireless data gateway, and an antenna to determine whether other alternate participant communications device 810 (e.g., another VoIP phone) may access signaling with the wireless data gateway and antenna serving the VoIP Phone 911 if the two alternate participant communications devices are in a similar geographic area.

Still other exemplary embodiments may include conference management features including a user interface for the host participant to manage conference resources (including administrative features, a profile of the host participant, a participant profile, “sharing features” such as a request to “borrow” an available port, an offer to “share” an available port, an incentive to “share” an available port, a request for an unassigned port, features to control connections with his/her ports including “shared” ports, and other management features) and to communicate and distribute conference materials. For example, the host participant can execute commands and/or instructions that delay presentment of the conference and/or presentment of conference materials until all participants (including excess participants) are connected with the conference call, modify one or more communications connection with and/or among participants, and/or other features. The communications connection may utilize a variety of communications networks, such as, for example, a telecommunications network (e.g., Public Switched Telephone Network (PSTN)), a data communications network (e.g., an Internet Protocol (IP) communications network), and/or a satellite network. Further exemplary embodiments provide a variety of host participant interfaces for the Hybrid Conferencing Module that include, for example, dual tone multi frequency (DTMF) signals, web-based interfaces (e.g., Internet), e-mail interfaces, interactive voice response interfaces, and others. Accordingly, the hybrid conferencing system leverages conferencing assets to provide an “always” available hybrid conferencing system for the host participant, participants, and/or excess participants.

The Hybrid Conferencing Module (shown as reference numeral 110 in FIGS. 1-8) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the Hybrid Conferencing Module to be easily disseminated.

Still in further exemplary embodiments, the Hybrid Communications Module may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol phone, a cellular phone, and any communications device having a digital signal processor.

While several exemplary implementations of embodiments of this invention are described herein, various modifications and alternate embodiments will occur to those of ordinary skill in the art. Accordingly, this invention is intended to include those other variations, modifications, and alternate embodiments that adhere to the spirit and scope of this invention.

What is claimed is:

1. A conferencing method, comprising the steps of:
allocating a conference bridge resource to a communications device of a host participant, the conference bridge resource having a selected number of conference ports, the selected number of ports supporting conference communications with a complimentary, selected number of participant communications devices;
assigning a communications address and an authentication code to the host participant, the communications address accessing a communications address of a conference gateway, the conference gateway communicating with the conference bridge resource, with at least one other conference bridge resource having another selected number of conference ports, and with a hybrid conference server, the authentication code authenticating a host participant;
routing an incoming conference communication from a participant communications device to the conference gateway to identify an availability of one of the selected number of conference ports:
if one of the selected number of conference ports is available, then connecting the incoming conference communication with the conference bridge resource for participation in a conference call,
if one of the selected number of conference ports is not available, then identifying a second conference bridge resource having an available conference port, configuring the available conference port of the second conference bridge resource to access the conference bridge resource via the conference gateway, and connecting the incoming conference communication with the available conference port of the second conference bridge resource for participation in the conference call.

2. The method of claim 1, further comprising the steps of:
associating the communications address with a conference code, the conference code authenticating an incoming participant communication;
receiving an incoming communication from the communications device of the host participant, the incoming communication comprising the communications address and the authentication code;
connecting the incoming communication from the host participant with the conference bridge resource for participation in the conference call;
receiving the incoming conference communication from a participant communications device, the incoming conference communication comprising the communications address and the conference code.

3. The method of claim 1, wherein the step of routing the incoming conference communication further comprises the step of:
prompting a communications device of a second host participant for authorization to share the available conference port of the second conference bridge resource, the second conference bridge resource allocated to the communications device of the second host participant.

4. The method of claim 3, further comprising the steps of:
receiving a reply from the communications device of the second host participant;
if the reply authorizes sharing, then configuring the available conference port of the second conference bridge resource to access the conference bridge resource via the conference gateway, and connecting the incoming conference communication with the available conference port of the second conference bridge resource for participation in the conference call; and
if the reply denies sharing, then identifying a third conference bridge resource having an available conference port, configuring the available conference port of the third conference bridge resource to access the conference bridge resource via the conference gateway, and connecting the incoming conference communication with the available conference port of the third conference bridge resource for participation in the conference call.

5. The method of claim 1, further comprising the step of:
prior to participation in the conference call, receiving a request from the communications device of the host participant to borrow an addition conference bridge resource.

6. The method of claim 5, further comprising the step of:
prompting a plurality of communications devices, each communications device associated with another unique host participant, the prompt comprising information about the conference call and a request to share an available conference port of another unique conference bridge allocated to a unique communications device of the unique host participant.

7. The method of claim 1, further comprising the step of:
during the conference call, receiving a request from the communications device of the host participant to borrow an addition conference bridge resource.

8. The method of claim 7, further comprising the step of:
prompting a plurality of communications devices, each communications device associated with another unique host participant, the prompt comprising information about the conference call and a request to share an available conference port of another unique conference bridge allocated to a unique communications device of the unique host participant.

9. The method of claim 1, further comprising the step of:
delaying participation in the conference call when a delay instruction from the communication device of the host participant is activated.

10. The method of claim 1, further comprising the step of:
controlling participation in the conference call according to a conference instruction from the communication device of the host participant, the conference instruction comprising an instruction to disconnect a selected, connected conference communication, an instruction to transfer a selected, connected conference communication from the available conference port of the second conference bridge resource to the conference port of the conference bridge resource allocated to the communications device of the host participant, an instruction to communicate conference materials, and an instruction to terminate participation in the conference call.

11. A system, comprising:
a hybrid conferencing module stored in a memory device, and a processor communicating with the memory device, the hybrid conferencing module:
allocating a conference bridge resource to a communications device of a host participant, the conference bridge resource having a selected number of conference ports, the selected number of ports supporting conference communications with a complimentary, selected number of participant communications devices;
assigning a communications address and an authentication code to the host participant, the communications address accessing a communications address of a conference gateway, the conference gateway communicating with the conference bridge resource, with at least one other conference bridge resource having another selected number of conference ports, and with a hybrid conference server, the authentication code authenticating a host participant;
routing an incoming conference communication from a participant communications device to the conference gateway to identify an availability of one of the selected number of conference ports:
if one of the selected number of conference ports is available, then connecting the incoming conference communication with the conference bridge resource for participation in a conference call,
if one of the selected number of conference ports is not available, then identifying a second conference bridge resource having an available conference port, configuring the available conference port of the second conference bridge resource to access the conference bridge resource via the conference gateway, and connecting the incoming conference communication with the available conference port of the second conference bridge resource for participation in the conference call.

12. The system of claim 11, the communications device of the host participant comprising an analog telephone, a computer, a voice-over internet protocol phone, a digital music device, a digital recording device, a personal digital assistant, an interactive television, a global positioning system, and a digital signal processor.

13. The system of claim 11, the participant communications device comprising an analog telephone, a computer, a voice-over internet protocol phone, a digital music device, a digital recording device, a personal digital assistant, an interactive television, a global positioning system, and a digital signal processor.

14. A storage medium on which is encoded instructions for performing the following:
allocating a conference bridge resource to a communications device of a host participant, the conference bridge resource having a selected number of conference ports, the selected number of ports supporting conference communications with a complimentary, selected number of participant communications devices;
assigning a communications address and an authentication code to the host participant, the communications address accessing a communications address of a conference gateway, the conference gateway communicating with the conference bridge resource, with at least one other conference bridge resource having another selected number of conference ports, and with a hybrid conference server, the authentication code authenticating a host participant;
routing an incoming conference communication from a participant communications device to the conference gateway to identify an availability of one of the selected number of conference ports:
if one of the selected number of conference ports is available, then connecting the incoming conference communication with the conference bridge resource for participation in a conference call,
if one of the selected number of conference ports is not available, then identifying a second conference bridge resource having an available conference port, configuring the available conference port of the second conference bridge resource to access the conference bridge resource via the conference gateway, and connecting the incoming conference communication with the available conference port of the second conference bridge resource for participation in the conference call.

15. The storage medium of claim 14, on which is further encoded instructions for performing the following:
prompting a communications device of a second host participant for authorization to share the available conference port of the second conference bridge resource, the second conference bridge resource allocated to the communications device of the second host participant.

16. The storage medium of claim 15, on which is further encoded instructions for performing the following:
receiving a reply from the communications device of the second host participant;
if the reply authorizes sharing, then configuring the available conference port of the second conference bridge resource to access the conference bridge resource via the conference gateway, and connecting the incoming conference communication with the available conference port of the second conference bridge resource for participation in the conference call; and
if the reply denies sharing, then identifying a third conference bridge resource having an available conference port, configuring the available conference port of the third conference bridge resource to access the conference bridge resource via the conference gateway, and connecting the incoming conference communication with the available conference port of the third conference bridge resource for participation in the conference call.

17. The storage medium of claim 14, on which is further encoded instructions for performing the following:
prior to participation in the conference call, receiving a request from the communications device of the host participant to borrow an addition conference bridge resource; and
prompting a plurality of communications devices, each communications device associated with another unique host participant, the prompt comprising information about the conference call and a request to share an available conference port of another unique conference bridge allocated to a unique communications device of the unique host participant.

18. The storage medium of claim 14, on which is further encoded instructions for performing the following:
during the conference call, receiving a request from the communications device of the host participant to borrow an addition conference bridge resource; and
prompting a plurality of communications devices, each communications device associated with another unique host participant, the prompt comprising information about the conference call and a request to share an available conference port of another unique conference bridge allocated to a unique communications device of the unique host participant.

19. The storage medium of claim 14, on which is further encoded instructions for performing the following:
delaying participation in the conference call when a delay instruction from the communication device of the host participant is activated.

20. The storage medium of claim 14, on which is further encoded instructions for performing the following:
controlling participation in the conference call according to a conference instruction from the communication device of the host participant, the conference instruction comprising an instruction to disconnect a selected, connected conference communication, an instruction to transfer a selected, connected conference communication from the available conference port of the second conference bridge resource to the conference port of the conference bridge resource allocated to the communications device of the host participant, an instruction to communicate conference materials, and an instruction to terminate participation in the conference call.
